(19) United States
(12) Patent Application Publication
(10) Pub. No.: US 2017/0363571 A1
(43) Pub. Date: Dec. 21, 2017

(54) ELECTROCHEMICAL TESTING SYSTEM

(71) Applicant: Commonwealth Scientific and Industrial Research Organisation, Acton (AU)

(72) Inventors: Michael Breedon, Clayton South (AU); Ivan Stuart Cole, Kew (AU)

(73) Assignee: Commonwealth Scientific and Industrial Research Organisation, Acton (AU)

(21) Appl. No.: 15/538,543

(22) PCT Filed: Dec. 23, 2015
(86) PCT No.: PCT/AU2015/050834

§ 371 Date: Jun. 21, 2017

(30) Foreign Application Priority Data
Dec. 23, 2014 (AU) 2014905253

(51) Int. Cl. G01N 27/416

(52) U.S. Cl. CPC G01N 27/416

(57) ABSTRACT

An electrochemical testing system, including: a testing board including: a plurality of testing wells, each well including a first well portion for holding a workpiece to be tested and bringing a first surface of the workpiece into contact with a separate working electrode lead for each testing well, a second well portion for holding a testing media and bringing a second surface of the workpiece into contact with the testing media, and a sealing mechanism for preventing contact of the testing media and the first surface of the workpiece; a media delivery system for selectively delivering the testing media into the second well portion; at least one sensing head for securing one or more electrochemical sensing elements at least one of which is adapted to form part of an electro chemical circuit with the testing media, workpiece and working electrode lead for each testing well, each testing well being electrically and physically isolated from other testing wells; testing apparatus for measuring electrochemical and/or chemical properties from the electrochemical circuit; and a motion control system for controlling relative movement of the sensing head and the plurality of testing wells so that the one or more sensing elements are selectively brought into contact with the testing media in the testing well of a selected workpiece to be tested.

### TECHNICAL FIELD

The present invention relates generally to electrochemical testing systems, and in particular to systems where fluid or other media is brought into contact with material to be tested and the electrochemical properties of that material are then measured by instrumentation.

### BACKGROUND OF INVENTION

Current high throughput electrochemical testing apparatus rely upon multiplexing traditional potentiostat/galvanostat equipment to bulky electrochemical cells, or utilise costly multi-channel potentiostat/galvanostats. This approach has a number of drawbacks, including cost, time taken to perform the electrochemical testing and the inevitable wastage of large volumes of liquid. Notably, existing apparatus require multiple reference electrodes, glass testing cells and counter electrodes to be purchased.

It would be desirable to provide an electrochemical testing system that permits high throughput studies which are capable of characterising complex electrochemical interactions over a large number of separate experiments. It would also be desirable to provide an electrochemical testing system that ameliorates or overcomes one or more disadvantages of known electrochemical testing apparatus and methodologies.

### SUMMARY OF INVENTION

One aspect of the present invention provides an electrochemical testing system, including: a test board including a plurality of testing wells, each well including a first well portion for holding a workpiece to be tested and bringing a first surface of the workpiece into contact with a separate working electrode lead for each testing well, a second well portion for holding a testing media and bringing a second surface of the workpiece into contact with the testing media, and a sealing mechanism for preventing contact of the testing media and the first surface of the workpiece; a media delivery system for selectively delivering the testing media into the second well portion; at least one sensing head for securing one or more electrochemical sensing elements at least one of which is adapted to form part of an electrochemical circuit with the testing media, workpiece and working electrode lead for each testing well, each testing well being electrically and physically isolated from other testing wells; testing apparatus for measuring electrochemical and/or chemical properties from the electrochemical circuit; and a motion control system for controlling relative movement of the sensing head and the plurality of testing wells so that the one or more sensing elements are selectively brought into contact with the testing media in the testing well of a selected workpiece to be tested.

The electrochemical testing system of the present invention enables multiple tests to be performed sequentially or in parallel and under the same environmental conditions through isolating (physically and electrically) the testing wells, thus forming multiple individually addressable electrochemical circuits to the respective workpieces, thereby increasing throughput and reducing systematic errors compared to conventional electrochemical testing systems.

Preferably, the testing apparatus measures the electrochemical properties of the workpiece or any of the substituent components that comprise the electrochemical circuit.

The workpiece is preferably selected from a group consisting of: manufactured products, natural products, scientific or research grade material(s)/sample(s), metal(s), alloy(s), textiles (natural and synthetic, including e-textiles), coatings/coated materials, nanomaterials, carbaceous materials, ceramic materials, composite materials, polymers, polymer blends, specialist glasses, metallic glasses, electroactive materials; or generally any electrochemically active material, One of the preferred embodiments uses a chemically “inert” (with respect to the reactivity of the media) material (e.g. Pt, Au, etc) as the workpiece, in order to electrochemically assess the testing media or electrolyte solution, finding utility in battery electrolyte formulation and similar media optimisation tasks.

Typical workpiece examples and their preferable applications may include one or more of the following: metal and alloy plates for the purposes of quality assurance (QA) and quality control (QC), screening corrosion inhibiting compounds and measuring their efficacy, or to screen the suitability of a given metal/alloy for a particular environmental extreme (e.g. in contact with acidic waste water); coated materials to assess the integrity of the coating or a screening method useful in the development of new coatings and formulations; battery electrode materials for QA/QC, screening of new electrode materials, assessment of electrolyte formulations to determine suitability and compatibility with electrode materials; for the assessment of electronic components which utilise electroactive or semiconducting materials in their construction, including but not limited to: capacitors, supercapacitors, ultracapacitors, batteries, solar cells, light dependant resistors, photodiodes, light emitting diodes and others known to those skilled in the art; testing and analysis of natural products such as those deemed to be of commercial or scientific importance; for the assessment, discovery and to inform the refinement of polymer(s) or polymer blends; testing and development of textile and related materials/products. It will be appreciated by those skilled in the art that these examples are by no means exhaustive, and that any material which can be electrochemically or non-electrochemically (as defined within this document) analysed can form part or the whole workpiece.

In one or more embodiments, the first well portion includes a body including a recess for receiving the workpiece and an opening in the body through which the working electrode lead passes to make contact with the first surface of the workpiece.

In one or more embodiments, the sealing mechanism includes a mechanical seal for location between the second surface of the workpiece and the second well portion and co-operating engagement members to cause the workpiece and the second well portion to bear against each other.

In one or more embodiments, the cooperating engagement members pass through aligned hole openings respectively in the first and second well portions. In other embodiments, the cooperating engagement members act to clamp or crimp surfaces of the first and second well portions together.

In one or more embodiments, the mechanical seals of the plurality of testing wells are unitary.

In one or more embodiments, one or both of the first well portions and the second well portions of the plurality of testing wells are unitary.

In one or more embodiments, the second well portion is formed from a chemically stable, electrically and ionically and/or non-conductive insulating material.

In one or more embodiments, the electrochemical sensing elements include one or more of a counter electrode, a reference electrode and a test probe.

In one or more embodiments, the test probe(s) is any one of a pH sensor or other ion-selective sensor/probe, a spectroscopic/hyperspectral measurement system/probe or an optical sensor.

In one or more embodiments, the at least one sensing head is adapted to secure one or more non-electrochemical sensing elements to perform non-electrochemical testing. Non-electrochemical testing is preferably testing of the material properties of the components making up the electrochemical circuit. Examples of non-electrochemical sensing elements include a spectroscopic/hyperspectral measurement system/probe or an optical sensor.

In one or more embodiments, the media delivery system includes media delivery tubing running between one or more media storage units and one or more media delivery output nozzles, and one or more operable pump units to selectively cause delivery of the media along the tubing and out of the nozzles.

In one or more embodiments, the media includes one or more of liquids, gel or solid. The media is preferably an electrolyte which may comprise one or more of the following: water, polar solvents, organic solvents, ionic liquids, corrosion inhibitors, stabilisation agents.

In one or more embodiments, the media delivery system is adapted to handle volumes of reagents/liquid/gels in the range of 1 nL to 1 L or more. More preferably, the media delivery system is adapted to handle volumes in the range 5 nL to 1000 ml, more preferably 1 ml to 500 ml, even more preferably 5 ml to 200 ml; and even more preferably 10 ml to 100 ml. The exact volumes used may depend upon the properties being tested.

In one or more embodiments, the one or more media delivery output nozzles are mounted to the sensing head.

In one or more embodiments, the electrical testing apparatus includes at least one electrical instrument having inputs connected to the working electrode lead and one or more of the sensing elements, and an output connected to measurement recording apparatus.

In one or more embodiments, the electrical testing apparatus further includes circuitry for connecting the working electrode of a selected testing well to the electrochemical measurement circuit.

In one or more embodiments, the motion control system includes a drive mechanism for driving one or both of the plurality of testing wells and sensing head along three orthogonal axes.

In one or more embodiments, the motion control system further includes a programmable controller configured for the operation of the drive mechanism and the electrical testing apparatus.

In one or more embodiments, the programmable controller is further configured to control operation of the media delivery system.

In one or more embodiments, the programmable controller is configured to execute a predetermined sequence of testing and/or calibration steps on workpieces held in one or more of the testing wells.

Another aspect of the invention provides a testing board for use with an electrochemical testing system as described above, the testing board including a plurality of testing wells, each well including

a first well portion for holding a workpiece to be tested and bringing a first surface of the workpiece into contact with a working electrode lead,

a second well portion for holding a testing media and bringing a second surface of the workpiece into contact with the testing media, and

a sealing mechanism for preventing contact of the testing media and the first surface of the workpiece.

In one or more embodiments, the first well portion includes:

a body including a recess for receiving the workpiece; and

an opening in the body through which the working electrode lead passes to make contact with the first surface of the workpiece.

In one or more embodiments, the sealing mechanism includes:

a mechanical seal for location between the second surface of the workpiece and the second well portion; and

co-operating engagement members to cause the workpiece and the second well portion to bear against each other.

In one or more embodiments, the cooperating engagement members pass through aligned openings formed respectively in the first and second well portions.

In other embodiments, the cooperating engagement members act to clamp or crimp surfaces of the first and second well portions together.

In one or more embodiments, the mechanical seals of the plurality of testing wells are unitary.

In one or more embodiments, one or both of the first well portions and the second well portions of the plurality of testing wells are unitary.

In one or more embodiments, the second well portion is formed from a chemically stable, electrically and ionically insulating and/or conductive material.

Another aspect of the invention provides use of the testing board to perform electrochemical testing, the test board including a plurality of testing wells, each well including a first well portion for holding a workpiece to be tested and bringing a first surface of the workpiece into contact with a separate working electrode lead for each testing well, a second well portion for holding a testing media and bringing a second surface of the workpiece into contact with the testing media, and a sealing mechanism for preventing contact of the testing media and the first surface of the workpiece, wherein

in an electrochemical testing system including the testing board, a media delivery system, testing apparatus, a motion control system and at least one sensing head for securing one or more electrochemical sensing elements at least one of which is adapted to form part of an electrochemical circuit with the testing media, workpiece and working electrode lead for each testing well, each testing well being electrically and physically isolated from other testing wells,

the media delivery system selectively delivers the testing media into the second well portion;

the testing apparatus measures electrical and/or chemical properties from the electrochemical circuit; and

the motion control system controls relative movement of the sensing head and the plurality of testing wells so that the one or more sensing elements are selectively brought into contact with the testing media in the testing well of a selected workpiece to be tested.

Another aspect of the invention includes a process for calibrating an electrochemical testing system as described hereabove, including the steps of:

placing a reference workpiece in one of more testing wells;

causing the media delivery system selectively delivering calibration testing media to the one of more testing wells holding reference workpieces;

causing the motion control system to control relative movement of the sensing head and the one of more testing wells holding reference workpieces so that the one or more sensing elements are selectively brought into contact with the calibration testing media; and

reading calibration values from the sensing elements.

The use of one or more of the wells to calibrate the sensing head ensures that the sensing heads are performing within specified calibration limits. The calibration well may comprise a blank sample or a reference sample which is preferably certified. The advantage of testing the experimental wells and calibration wells co-currently is that systematic errors related to environmental conditions can be quantified.

Another aspect of the invention provides a process for using an electrochemical testing system as described hereabove, including the steps of:

loading identical workpieces which can be loaded into a plurality of testing wells; and

running identical testing procedures on the plurality of testing wells.

The present invention is particularly beneficial in being able to rapidly screen multiple samples without the need for repeat testing. However, the high throughput capacity of the present invention does also allow for multiple testing of the sample experiments, when statistical rigor is required. For example, when measuring parameters which have a high random error, at least two or three experiments may be run.

Another aspect of the invention provides a process for using electrochemical testing system as described hereabove, including the steps of:

running identical testing procedures on the same testing well multiple times.

This type of testing includes cyclic testing in which the electrochemical properties of a system may be tested after each charge/discharge cycle or internals thereof. Cyclic testing are an important benchmark used by industry, with the scaling up of an particular electrochemical cell often not progressing until cyclic performance has been determined. The present invention enables a greater number of electrochemical cells to undergo cyclic testing and thereby provide a greater opportunity of optimising cell chemistry.

### Definitions:

Electrochemical properties: Properties relating to the chemical reactions which take place at the interface of an electrode and involve electric charges moving between the electrodes and the electrolyte. Properties may include ionic conductivity, capacitance and the window of electrochemical stability. Electrochemical measurements may include potentiometry, amperometry, coulometry, voltammetry (including cyclic voltammetry), potentiometry and impedance spectroscopy.

Chemical properties: Properties relating to the chemistry of a substance which may include their electrochemical properties.

### BRIEF DESCRIPTION OF DRAWINGS

The following description refers to in more detail to the various features of the present invention. To facilitate an understanding of the invention, reference is made in the description to the accompanying drawings where the electrochemical testing system is illustrated in a preferred embodiment. It is to be understood that the electrochemical testing system of the present invention is not limited to the preferred embodiment as illustrated in the drawings.

In the drawings:

FIG. 1 is a schematic diagram of an electrochemical testing system according to one embodiment of the present invention;

FIGS. 2(a) and 2(b) are isometric and plan views respectively of two layers of a testing board forming a plurality of testing wells forming part of the electrochemical testing system shown in FIG. 1;

FIGS. 3(a), 3(b) and 3(c) are isometric views of the layer of the testing board shown in FIG. 2(b) and depicts a sequence of operations during use of the electrochemical testing system shown in FIG. 1 to test a workpiece held in the testing board shown in FIG. 2;

FIGS. 4(a) to (c) depict respectively a plan, side and bottom view of a portion of the testing board shown in FIG. 2 after assembly is complete;

FIG. 5 is a schematic side view of a sensing head forming part of the electrochemical testing system shown in FIG. 1;

FIG. 6 is a schematic plan view of the sensing head shown in FIG. 5;

FIG. 7 is an illustrative electrical connectivity diagram of the sensing head shown in FIGS. 5 and 6 when positioned so that sensing elements held by the sensing head are brought into contact with testing media in a testing well forming part of the testing board shown in FIG. 2;

FIG. 8 is a schematic diagram of a computer system forming part of the electrochemical testing system shown in FIGS. 1; and

FIGS. 9 and 10 are flow charts depicting a sequence of operations performed by the electrochemical testing system shown in FIG. 1.

### DETAILED DESCRIPTION

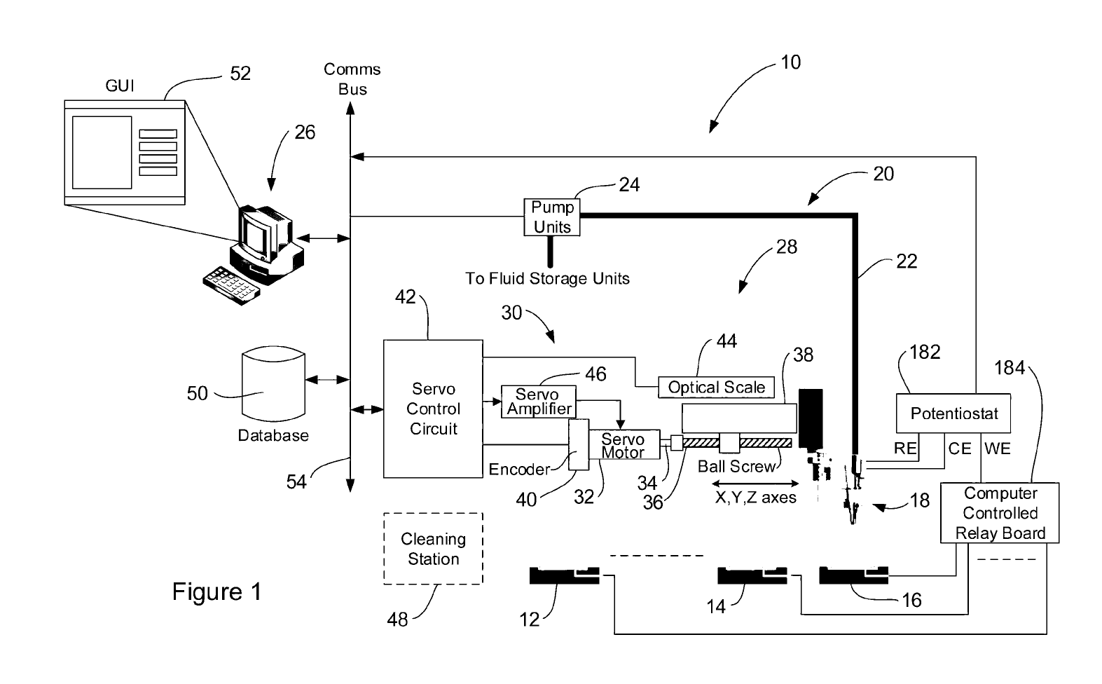

Referring now to FIG. 1, there is shown generally an electrochemical testing system 10 for testing workpieces held in a plurality of testing wells the exemplary ones of which are referenced 12 to 16 in this figure. The number of testing well are only limited by practical consideration, but are preferably comprise at least 5 testing wells, preferably at least 10 testing wells, more preferably at least 50 testing wells and even more preferably at least 100 testing wells. The testing wells 12 to 16 are each capable of holding a workpiece to be tested and forming a contained volume into which a testing media or electrolyte, such as a suitable fluid or gel, is introduced and brought into contact with the workpiece.

The electrochemical testing system 10 includes a sensing head 18 for securing one or more sensing elements, such as one or more electrodes or ion-selective probes. One or more sensing elements may be adapted to form part of an electrochemical circuit, together with the testing media in each of the testing wells 12 to 16, the workpiece itself and a working electrode lead that makes contact with the workpiece held within a relevant well. In such an arrangement, the workpiece effectively becomes the working electrode of the electrochemical testing system 10. It will be appreciated that not every sensing element need form part of an electrochemical testing circuit. For example, one or more sensors/probes (e.g. pH, spectroscopic, hyperspectral, optical) may be secured to the sensing head 18 for in situ data collection of important and/or complimentary data useful to an experimenter.

A number of sensing heads each supporting one or more sensing elements may be prepared in advance. The various sensing heads may be interchangeable to facilitate the rapid testing of workpieces.

At least one sensing head may be adapted to secure one or more non-electrochemical sensing elements to perform non-electrochemical testing and measure one or more non-electrochemical properties such as compositional characteristics of the media and/or workpiece (e.g. electrode), such as moisture content, degradation by-products and migrated species.

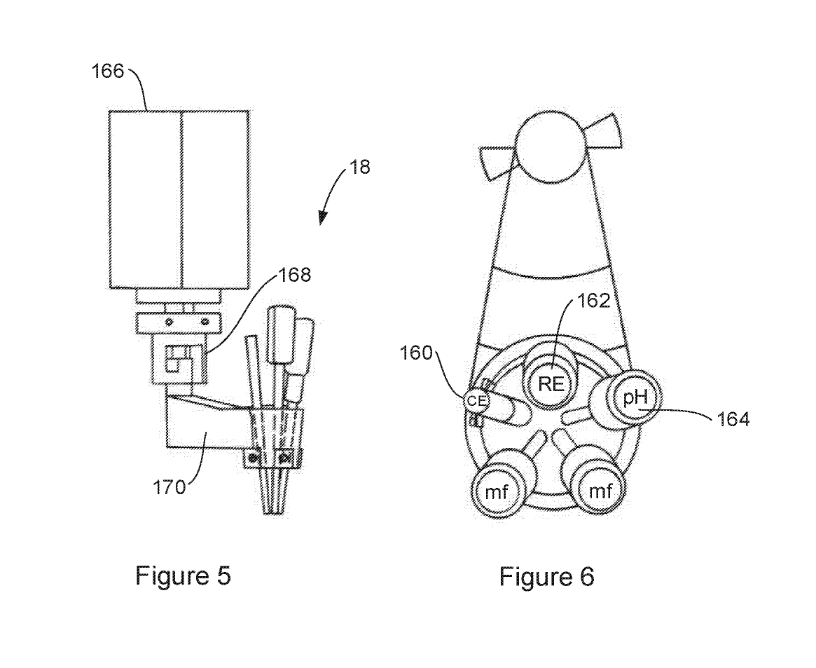

For example, the non-electrochemical sensing/analysis elements may include a raman spectroscopic system/probe or a fibre-optic camera, ion selective electrodes, solid-state physical or chemical sensors, macroscopic imaging systems, microscopic imaging systems, NIR imaging, UV-Vis systems, FTIR systems, general measurement/analysis techniques and those considered state-of-the-art. The electrochemical testing system 10 also includes a media delivery system 20 for selectively delivering fluid, gel or other testing media into the testing wells 12 to 16. The media delivery system 20 notably includes exemplary media delivery tubing 22 running between one or more media storage units (not shown) and one or more media delivery output nozzles which will be explained in relation to FIG. 5. One or more pump units 24 are provided as part of the media delivery system 20 to selectively cause delivery of the media along the tubing 22 and out of the nozzles. The media delivery system 20 is adapted to handle volumes of liquid in the range of 1 nL to 1 L or above.

In some embodiments, the media is in a solid form (e.g. solid electrolyte), such as a film or composite material (e.g. ion conducting polymers) The media delivery system is such embodiments preferably comprises a robotic “pick and place” mechanism which transfers pre-cut solid electrolytes into the wells. An alternative mechanism is deliver of the solid electrolyte as a film covering the wells and then cutting (mechanically or via laser) a proportion of the film above the well, such that the film portion is deposited into the well after cutting. It would be understood that other variations of the delivery of the media would be available to those skilled in the art.

A programmable controller 24 is configured to control operation of the media delivery system 20 including controlling operation of the pump units 24. As the media delivery system 20 is controlled by the programmable controller 26, it is possible to actively control the dosage and desired chemical delivery for each testing well 12 to 16.

In various embodiments of the invention, the pump units 24 may be either analogue or digitally controlled and may include but are not limited to syringe pumps, diaphragm pumps, peristaltic pumps, mechanical pumps, impellor pumps, as well as conventional pumping, dosage and metering techniques or solutions.

Connections between the pump units 24 and the micro-fluidic tubing or other piping is preferably chemically resistant and leak proof.

Although not depicted in FIG. 1, solenoids may also be included in the fluid path 22 to arrest, or redirect media flow when used in conjunction with a manifold suitable for fluid or viscous liquids. Inline mixing chambers may also be included in the fluid path. The nozzles or other outputs from the tubing 22 connected to the pump units may either be terminated individually at the sensing head 18 as shown in FIG. 1, or combined together upstream in a fluid path to ensure adequate mixing of solutions, gels or other media. Moreover, whilst FIG. 1 depicts the mounting of the nozzles at the sensing head 18, it is also possible to provide a separate media delivery system operating independently of and physically apart from the sensing head 18.

The electrochemical testing system 10 also includes a motion control system 28 for controlling relative movement of the sensing head 18 and the testing wells 12 to 16 so that one or more sensing elements mounted to the sensing head 18 are selectively brought into contact with testing media held within a selected one of the testing wells 12 to 16 in which a selected workpiece to be tested is held. The motion control system 28 may take a number of forms, but in one or more embodiments includes a servo or other drive mechanism 30 for driving one or both of the testing wells 12 to 16 and the sensing head 18 along three orthogonal axes.

In the embodiment depicted in FIG. 1, the servo mechanism 30 includes a servo motor 32 driving a spindle 34 which in turn connects to a ball screw 36. Operation of the servo motor 32 causes rotation of the ball screw 36 about its longitudinal axis. A coupling device 38 interconnects the sensing head 18 and the ball screw 36 so that the rotational movement of the ball screw 36 is translated into linear movement of the coupling device 38. It will be appreciated that the arrangement depicted in FIG. 1 is replicated along X, Y and Z orthogonal axes in order to provide three dimensional movement of the sensing head 18.

An encoder 40 is coupled to the servo motor 32 and provides a series of pulses to the servo control circuit 42 to enable a determination of the angular position of the spindle 34. In addition, an optical scale 44 converts linear movement of the coupling device 38 in the X, Y or Z axis into pulses to enable the servo control circuit 42 to determine the linear position of the coupling device 38 along each of the three orthogonal axes. The servo motor 32 is controlled by signals from a servo amplifier 46 which is in turn controlled by the servo control circuit.

It will be appreciated that the servo mechanism 38 is merely one example of an arrangement for selective positioning of the sensing head with respect to the testing wells. Other embodiments of the invention may include a combination of components conventionally used in servo mechanisms, such as transducers, stepper motors, actuators and servos. It will also be appreciated that in other embodiments of the invention relative positioning of the sensing head 18 and the testing wells 12 to 16 may provide along three or more axis of movement.

In use, the servo control circuit 42, acting under control of the programmable controller 26, typically causes the sensing head 18 to be positioned over a relevant testing well 12 to 16. The sensing head 18 is then lowered into the relevant testing well, and reagents, fluid or other testing media is dispensed into the relevant testing well as required. A testing sequence then begins, and after conclusion the sensor head is retracted from the well. The sensor head 18 may then be moved by the servo control circuit 42 to a cleaning station 48 where the sensor head 18 is decontaminated with de-ionised water or any appropriate fluid/solvent/chemical/gas, etc. The electrochemical testing system 10 is then ready to begin the next step.

A variety of reagents, fluid or other testing media can be dispensed into the testing wells, such as electrolytes, ionic liquids, solvents, stabilisation agents and corrosion inhibitors. Examples of the testing media or electrolyte that may be used are listed in paragraphs 18 to 75 of EP1365463. Examples of electrode materials which may form part of the electrochemical testing system are listed in paragraphs 70 to 94.

In some embodiments, individual electrolyte components can be directly deposited into the wells. This is advantageous in regard to reducing contamination, including cross contamination, degradation (e.g. oxidation) and minimising wastage. The open cell structure of the testing wells also facilitates the dosing of highly viscous materials (e.g. ionic liquids) and enabled dosing pipes to be heated to facilitate flow.

Moreover, while it is possible to pre-dispense liquids before testing, the system 10 facilitates on-demand dosing, thus mitigating issues of evaporation during long testing cycles which would typically range from 3 to 7 days.

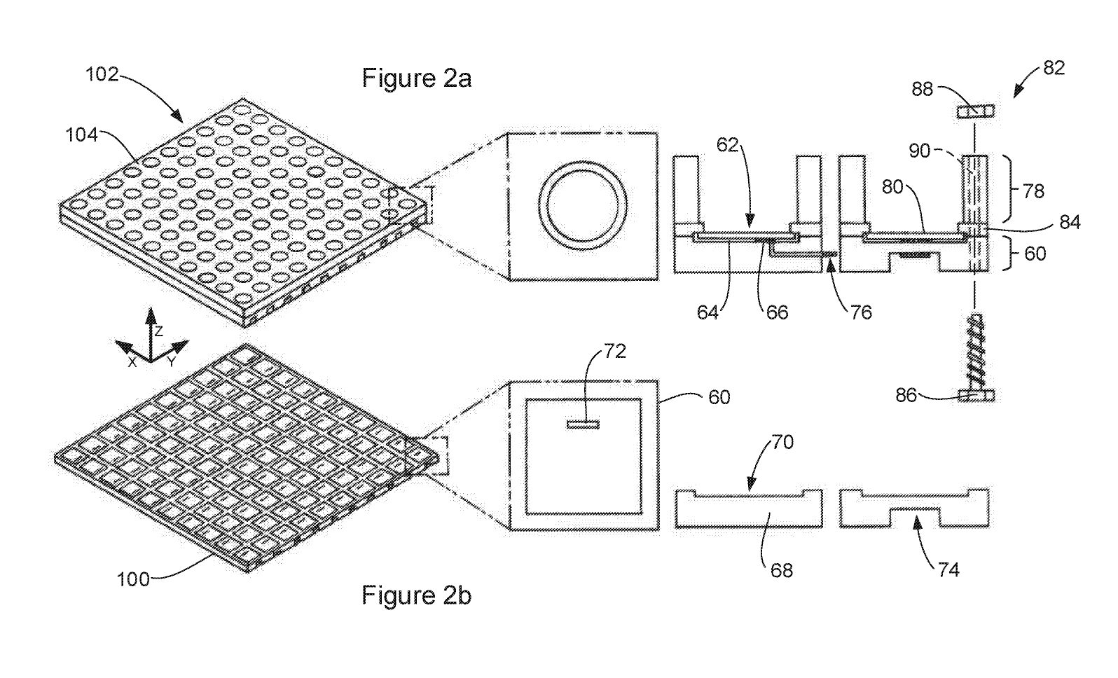

As can be best seen in FIG. 2, each of the testing wells 12 to 16 includes a first well portion 60 for holding a workpiece 62 to be tested. The first well portion 60 also acts to bring a first surface 64 of the workpiece into contact with an end of working electrode lead 66. In that regard, the first well portion 60 includes a body 68 having formed therein a recess 70 for receiving the workpiece 62. An aperture 72 is formed through the body 68 providing communication between the recess 70 at the interior of the testing well and an exterior surface 74 of the testing well. The working electrode lead passes through the aperture 72 to make contact with the surface 64 of the workpiece 62 thereby providing an externally accessible electrical connection to the surface 64 of the workpiece 62. In other embodiments, a recess, trough or other opening may be used in place of the aperture 72.

Each testing well also includes a second well portion 78 for holding a fluid, gel or other testing media, and for bringing a second surface of the workpiece 62 in to contact with the testing media. A sealing mechanism 82 is also provided for preventing contact of the testing medium and the first surface 64 of the workpiece 62. The second well portion 78 is preferably formed from a chemically stable, electrically and ionically insulating and/or non-conductive material

In the embodiment depicted in FIG. 2, the sealing mechanism 82 includes a mechanical seal, such as a gasket 84, for location between the second surface 80 of the workpiece 62, as well as cooperating engagement members to cause the workpiece 62 and the second well portion 78 to be against each other. The cooperating engagement members, which may include a plurality of nuts and bolts, pass through aligned openings formed respectively in the first and second well portions. In FIG. 2, an exemplary bolt 86 and corresponding nut 88 are depicted. The bolt 86 passes through an aperture 90 formed respectively in the first well portion 60 and second well portion 78. In other embodiments, the cooperating engagement members may be crimps or clamps that act to crimp or clamp surfaces of the well portions 60 and 78 together.

It will be appreciated that a variety of means may be provided to prevent contact of the testing media and the first surface 64 of the workpiece 62. Such sealing arrangements may include application of liquid sealants and adhesives, although these alternative embodiments would make disassembly of the testing wells into the component parts more difficult.

The various testing wells forming part of the electrochemical testing system 10 may form part of a testing board or other larger structure. In the embodiment depicted in FIG. 2, the first well portions of the various testing wells are unitary form the lower half 100 of a testing board 102. The second well portions of the testing wells are also unitary and in this embodiment form a top half 104 of the testing board 102. Although in this embodiment the gaskets used in the sealing mechanisms of each testing well are individually formed and applied, in other embodiments of the invention the gaskets may also be unitary and that unitary structure applied to the bottom half 100 of the testing board 102 prior to placement of the top half 104 over the gaskets.

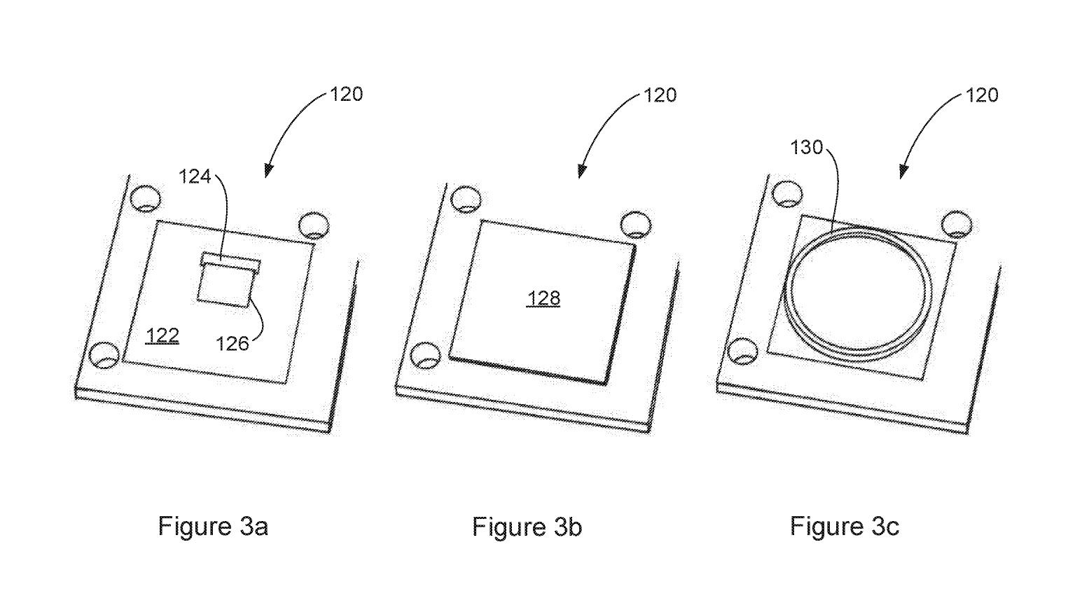

A more detailed view of a first well portion 120 forming part of a unitary structure can be seen in FIG. 3. This figure also depicts the recess 122 formed in the body 120, the aperture 124 formed through the body 120 and into the recess 122, the working electrode lead 126 passing through the aperture 124 for making contact with a workpiece 128 that is subsequently located in the recess 122. Finally, this figure depicts an exemplary circular gasket 130 located on the upper surface of the workpiece 128 and against which a second or upper well portion is subsequently located.

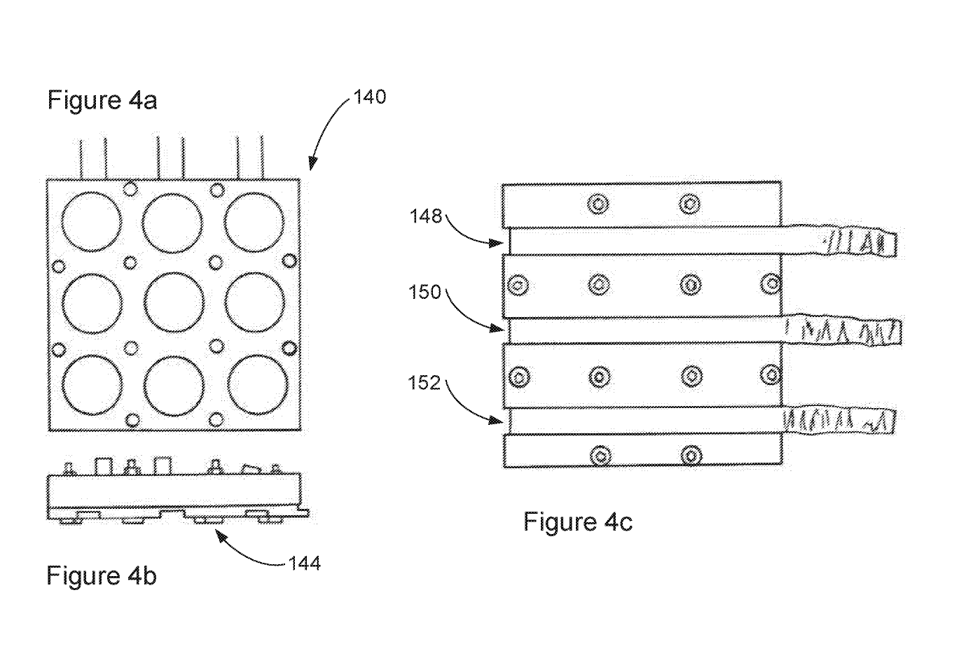

FIG. 4 shows in more detail a small exemplary testing board sub-unit 140 and notably depicts the manner in which a plurality of bolts 144 and nuts 146 are used as part of a sealing mechanism for preventing contact of the testing media with an upper surface of the workpiece located in the testing wells. It should be noted that alternative methods for maintaining the unitary configuration of testing board 140 in FIG. 4 may also include other mechanical or chemical methods such as crimps or adhesive media, or methods known to those skilled-in-the-art. In addition, this figure shows the manner in which working electrode leads from each of the testing wells run along grooves 148 to 152 in order to bring electrical connections to those working electrode leads to a convenient external location so that the working electrode leads can form part of an electrode chemical circuit for testing.

The number of testing wells in a testing board is preferably as high as can be physically accommodated by the mechanical range of the motion control system 28 and the physical space limitation of the testing area. In one exemplary system, 81 testing wells are used, with individual testing boards assembled as 9 well sub-units of the sort depicted in FIG. 4. Liquid volume of the testing cell should be in the 10's of mL range, while smaller volumes are possible, oxygen diffusion rates (if testing in ambient environments) become very high, and the equilibrium of the electrochemical system shifts, which can result in non-representative data. In some instances, low testing volumes may be desirable, as a sort of accelerated testing.

It will be appreciated that the testing board depicted in FIG. 2 serves to hold the workpieces in place, provide a physical scaffold onto which an electrical connection to the working electrode lead can be established, and seals the workpiece against the upper portion of the testing board, creating a testing space into which liquids, solids and gels can be brought into direct contact with the workpiece.

The working electrode can be made of any electro active material, typical examples of which are pure metals, alloys, carbon containing materials, and intercalation electrode such as metal oxides. In order to test non-idealised samples the first and second well portions and sealing mechanism can be modified to accept a variety of different geometries, extending testing capabilities past planar samples. Unlike other electrochemical testing systems which are limited to research and development, the electrochemical testing system described here is capable of testing manufactured samples/object, which is particularly important as idealised research and development samples are often not truly representative mass produced materials, which is what will ultimately be the contextualised focus of an industrially relevant electrochemical testing system.

The upper portion of the testing board 102 is preferably made from any chemically resistant material which also provides electrical insulation.

In other embodiments of the invention, the component testing board 102 may be fabricated as a single piece. It is also possible to fabricate the testing board to accommodate a larger or smaller number of wells as depicted in FIG. 2. Therefore, it is possible to fabricate smaller sub units of the testing board which may be combined to make one larger testing board.

It is to be understood that the diameter of the wells must be sufficient to suit experimental requirements, however, the wells should ideally be of sufficient volume to prevent displacement of the testing media and sensors or probes from the sensing head 18 are inserted into the well.

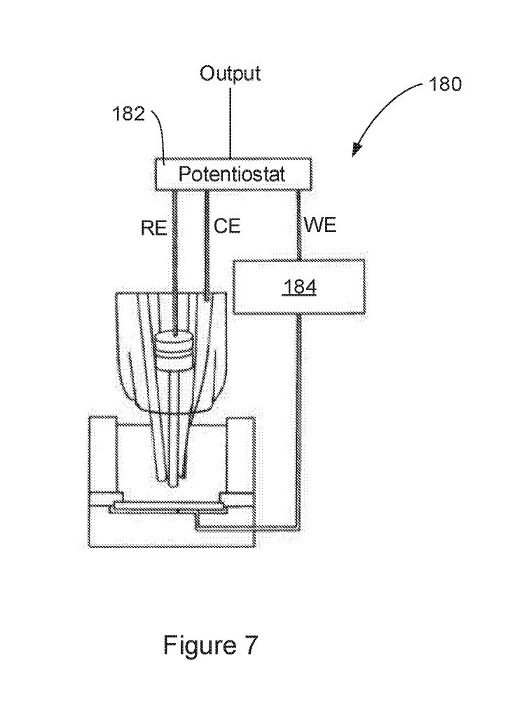

As seen in FIGS. 5 and 6, the sensing head 18 used to secure one or more sensing elements each adapted to form part of an electrochemical circuit with the testing media workpiece/working-electrode lead. These sensing elements include a counter electrode 160, a reference electrode 162 and a pH sensor 164. In other embodiments of the invention, other ion-selective probes may be provided as an alternative to or in addition to the pH sensor 164. In further embodiments, spectroscopic measurement techniques and a variety of other probes and sensors could be used in addition to or as an alternative to the arrangement shown in FIGS. 5 and 6. The sensing head 18 is used to secure the various sensing elements 160 to 164 to the motion control system 28. In that regard, the sensing head 18 is connected to the end of a robotic manipulator 166 by means of a bayonet fitting 168 permitting rapid removal of the sensing head 18. The sensing elements 160 to 164 are connected to the bayonet fitting 168 by an assembly 170.

It will be appreciated that in other embodiments, two or more of the elements depicted in FIGS. 5 and 6 may be formed as a single part.

The counter electrode 160 can be made from carbaceous materials or noble metals Pt, Au, etc. A fritted referenced electrode is typically employed (e.g. including Ag/AgCl, Calomel, specialist fritted electrodes where the solution is non-aqueous. Quasi-referenced electrodes, such as Ag, Pt, etc, may also be used.

Sensor head materials which incorporate the electrodes and other sensors can be made from materials such as metals, alloys, plastic/polymer(s), ceramics or the like.

The size and geometry of the electrodes should ideally be aligned so that they can be inserted into the testing well without completely displacing the solution or damaging the electrodes themselves.

To complete the electrochemical circuit which is necessary to perform electrochemical measurements of the workpiece, each testing well is electrically addressable and electrically and physically isolated from all other testing wells. This prevents the marring of electrochemical measurements by parasitic or concurrent chemicals/mechanical/electrochemical processes that would occur if testing occurred on a single workpiece only.

Utilising individual workpieces rather than a larger approximate sample means that individual manufactured components can also be tested. Some examples of manufactured samples could include: screws, nuts, bolts, washers, metal coupons, enclosures, wire, coils, cylinders, vessels, panelling, bearings, capsules, containers, shielding, etc.

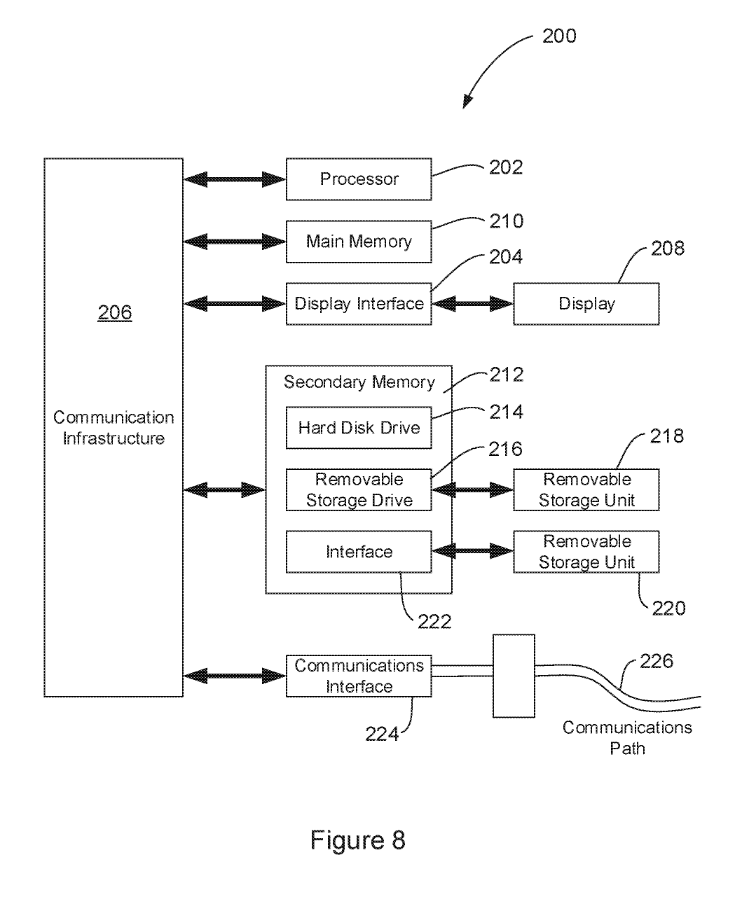

An example of testing apparatus for measuring electrochemical and/or chemical properties from the electrochemical circuit is shown in FIG. 7. In this exemplary implementation, the electrical testing apparatus 180 includes at least one electrochemical measurement instrument, in this case a potentiostat 182, having inputs connected to the working electrode and one or more of the sensing elements (in this case both the reference electrode and counter electrode). The potentiostat also includes an output connected to measurement recording apparatus, which in this case is embodied by the programmable controller 26 in conjunction with the database 50 shown in FIG. 1.

Whilst the potentiostat 182 measures the voltage difference between a working electrode and a reference electrode in an electrochemical cell, it is to be understood that a variety of probes, sensors and instruments can be used to measure a range of electrochemical properties.

To establish an electrical/electronic circuit between one or more instruments, such as the potentiostat 182, a galvanostat, other scientific/analytical measurement instrument(s) or data logging device(s), and the testing board 102, many connections can conveniently be multiplexed into a single connection by circuitry, such as a multiplexer 184, that connects the working electrode of a selected testing well to the electrochemical testing circuit. Conventional multiplexers, relay arrays (for example, reed, mechanical, micro, etc.) or other single switching/shunting technologies can be employed.

In other embodiments, a bus topology network may be used in place of the multiplexer 184 to simplify circuit design. In such a network, each instrument would be connected to a single cable or backbone and individually addressable on that backbone by the programmable controller 26.

Addressing of the individual testing wells is carried out by the programmable controller 26. The sensors, electrodes and other devices residing within the testing head 18 (as a stand-alone unit, or as part of an interchangeable arrangement) can be directly wired into testing/analytic instrumentation.

Alternatively, electrical connection to the reference and counter electrodes, pH probe or other attached sensors/probes can occur via multiple single-core or several multi-core cables/wiring to one or more patch panels located near the motion control system 28. Such panels allow for the rapid connection of instrumentation and power sources to sensors, electrodes, probes, motors, light sources or any utilised attachment.

It is also possible to use wireless or optical transmission in lieu of conductive wiring to achieve the same functionality/connectivity. It is also possible to use a bus connection topology to eliminate the need for electrically individually addressable testing wells. This eliminates the need for a multiplexing system, thus simplifying the design shown in FIGS. 1 and 7.

Operation of the servo mechanism 30, electrical testing apparatus 180, media delivery system 20 and other elements of the electrochemical testing system 10 is achieved by the programmable controller 26. In that regard, data from connected instruments, pumps and ancillary devices is captured by the programmable controller 26 and stored in the data base 50. A graphical user interface 52 is provided to enable an operator to set up a testing routine, control movement of the motion control system, analyse data and provide real time output of events, including error messages and take like actions. Data is stored in the database 50 on a per-experiment basis, with all variables such as inputs, outputs and time stamps recorded in the database 50.

The graphic user interface 52 enables individual samples to be electronically registered by an operator with a unique sample ID and material ID. In that regard, barcodes, RFID tags or other machine readable identifiers can be applied to individual samples, and read by a manual operable tag/code reader or the like. Calibration or re-zeroing and positioning of the motion control system 28 can also be performed by a user. The graphic user interface 52 can also enable an operator to specify parameters of media delivery system components such as flow rate, allow manual definition of what volume of which chemical is to be dispensed in any given testing well, enable users a selection of scan settings, testing protocols etc, as well as a variety of other user operable functionality that may be programmed in to the programmable controller 26.

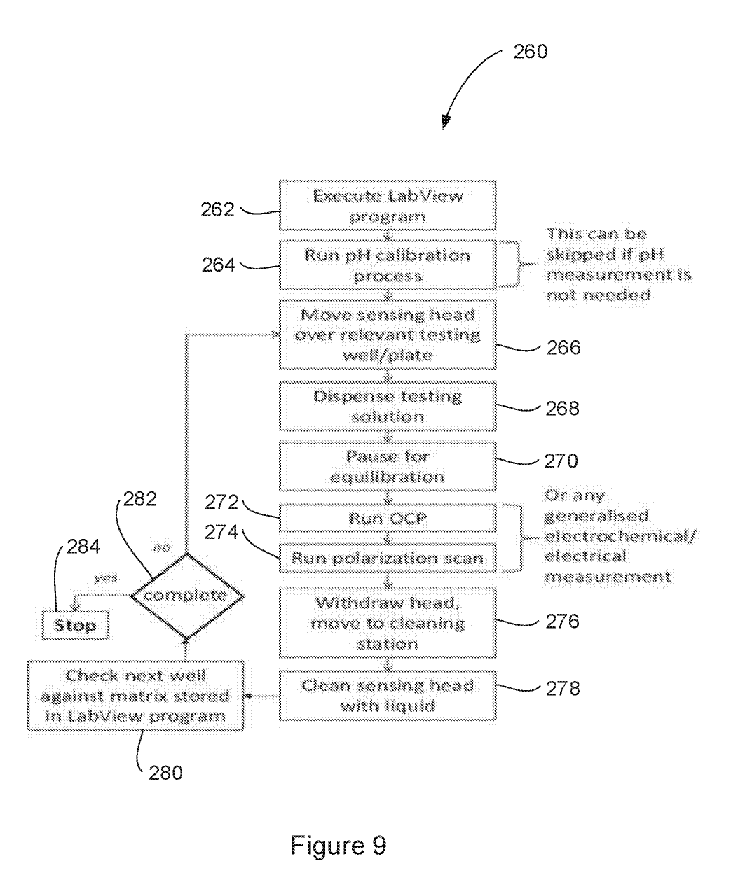

The programmable controller 26 and graphic user interface 52, as well as various other elements of the electrochemical testing system 10, may be provided by one or more computer systems capable of carrying out the above described functionality. An exemplary computer system 200 is depicted in FIG. 8. The computer system 200 includes one or more processors, such as the processor 202. The computer system may include a display interface 204 that forwards graphics, text and other data from a communication infrastructure 206 or display to a display unit 208. The computer system 200 may also include a main memory 210, preferably random access memory, and may also include a secondary memory 212.

The secondary memory 212 may include, for example, a hard disc drive 214, or optical disk drive or the like. A removable storage drive 216 reads from and/or writes to the removable storage unit 218 in a well-known manner. The removable storage unit 218 represents an optical disc, CD, DVD or like data storage device.

As will be appreciated, the removable storage unit 182 includes a computer usable storage medium including a non-volatile memory having stored therein computer software in the form of a series of instructions to cause the processor 202 to carry our desired functionality. In alternative embodiments, the secondary memory 212 may include other similar means for allowing computer programs or instructions to be loaded into the computer system 200. Such means may include, for example, a removable storage unit 220 and corresponding interface 222.

The computer system 200 may also include a communications interface 224. The communications interface 224 allows software and data to be transferred between the computer system 200 and external devices. Examples of the communication interface may include a modem, network interface, communications port. Software and data transfer via the communications interface 224 are in the form of signals which may be electro-magnetic, electronic, optical or other signals capable of being received by the communications interface 224. The signals are provided to the communication interface 224 via a communications path 226 such as a wire, cable, fibre optics, phone line, cellular phone link, radio frequency or other communication channel, including the communications bus 54 depicted in FIG. 1.

In the context of the present invention it is to be understood that the “computer system” is intended to encompass arrangements that are less complex than the computer system 200, including notably a microcontroller, microprocessor or the like.

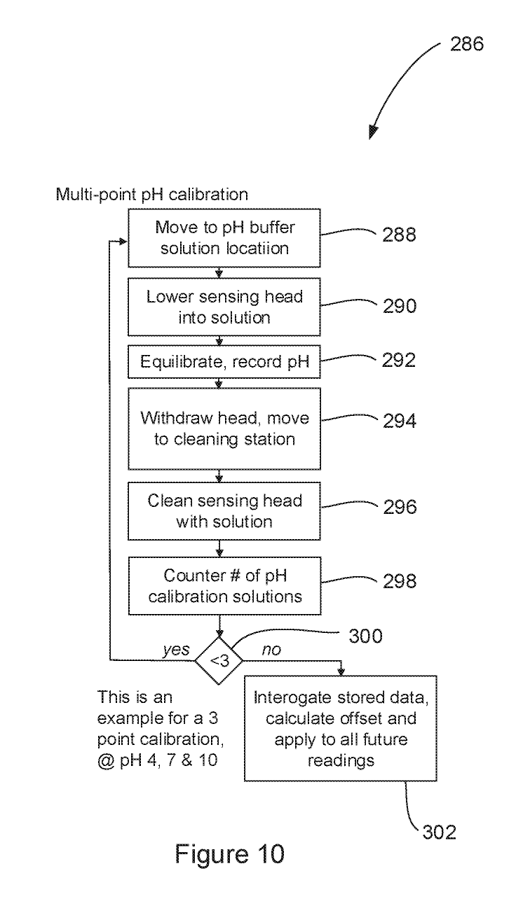

FIGS. 9 and 10 depict two exemplary testing procedures performed by the electrochemical testing system 10 under control of the programmable controller 26. In the testing procedure 206 depicted in FIG. 9, the graphic user interface 52 is activated at step 262, from where an operator selects to run a pH calibration process at step 264. Acting under the control of the programmable controller 26, the motion control system 28 acts to then move the sensing head 18 over a relevant testing well at step 266. At step 268, the programmable controller 26 causes the media delivery system 20 to dispense an appropriate amount of testing liquid/solution/gel and applicable reagents into the relevant well.

After a pause for equilibration at step 270, a generalised electrochemical measurement is performed, such as determining the open circuit potential of the electrochemical circuit being tested at step 272 or in a polarisation scan at step 274.

Once these measurements have been performed, the testing head 18 is withdrawn from the testing well at step 276, and moved to the cleaning station 48, where at step 278, the sensing head 18 is cleaned with suitable cleaning fluid.

At step 280, the programmable controller 26 determines whether additional tests are to be run. If it is determined at step 282 that all testing has completed, then operation of the electrochemical testing system 10 ceases at step 284.

An example of the pH calibration testing procedure 286 is depicted in FIG. 10. In general terms, this procedure, a reference workpiece is placed in one or more testing wells. The media delivery system then selectively delivers calibration testing media to the one of more testing wells holding reference workpieces, and the motion control system is caused to control relative movement of the sensing head and the one of more testing wells holding reference workpieces so that the one or more sensing elements are selectively brought into contact with the calibration testing media. Calibration values are then read from the sensing elements.

Specifically, the procedure depicted in FIG. 10 relates to a multi-point pH calibration performed by the electrochemical testing system 10. In this testing procedure, the testing head 18 is moved to a pH buffer solution stored in one of the testing wells or other suitable location at step 288. At step 290, the sensing head is lowered into the solution and, at step 292, after a pause for equilibration, the pH is recorded.

At step 294, the sensing head 18 is withdrawn and moved to the cleaning station 48 where the sensing head is cleaned at step 296. At step 298, a count is made of the number of pH calibration solutions that have been calibrated and, if it is determined at step 300 that less than a desired number of calibrations have occurred, then steps 288 to 298 are repeated. Once the desired number of calibrations have taken place, then at step 302, the stored data in the database 30 is interrogated and the programmable controller 26 acts to calculate a calibration offset which is to be applied to future readings. In other words, the pH calibration is run for pH 4, 7 and 10 (once for each calibration solution), after which generalised testing begins from step 266 onwards in FIG. 9.

The electrochemical testing system 10 can be designed for rapid screening in which each testing well is used to perform a discrete testing procedure without repeats.

However, the electrochemical testing system 10 can also be configured to perform testing procedures, such as those depicted in FIGS. 9 and 10, on multiple samples in parallel. That is, identical workpieces can be loaded into a plurality of testing wells and identical testing procedures run. A repeat function can easily be programmed into the computer system 200 which will perform the same test in two or more testing wells, which improves the general scientific rigour of the system and makes it compatible with standard testing procedures. For example, three separate samples can be measured and the results averaged.

The electrochemical testing system 10 can also be configured to perform cyclic testing, where each individual test well is tested multiple times. This is extremely useful for performing aging studies of materials and perturbing samples to environmental/system extremes to monitor the response of the sample.

While the invention has been described in conjunction with a limited number of embodiments, it will be appreciated by those skilled in the art that many alternatives, modifications or variations in light of the foregoing description are possible. The present invention is intended to embrace all such alternatives, modifications and variations as may fall within the spirit and scope of the invention as disclosed.

1. An electrochemical testing system, comprising:
a testing board including a plurality of testing wells, each well comprising:
a first well portion for holding a workpiece to be tested and bringing a first surface of the workpiece into contact with a separate working electrode lead for each testing well,
a second well portion for holding a testing media and bringing a second surface of the workpiece into contact with the testing media, and
a sealing mechanism for preventing contact of the testing media and the first surface of the workpiece;
a media delivery system for selectively delivering the testing media into the second well portion;
at least one sensing head for securing one or more electrochemical sensing elements at least one of which is adapted to form part of an electrochemical circuit with the testing media, workpiece and working electrode lead for each testing well, each testing well being electrically and physically isolated from other testing wells;
a testing apparatus for measuring electrochemical and/or chemical properties from the electrochemical circuit; and
a motion control system for controlling relative movement between the sensing head and the plurality of testing wells so that the one or more sensing elements are selectively brought into contact with the testing media in the testing well of a selected workpiece to be tested.

2. The electrochemical testing system of claim 1, wherein the first well portion comprises:
a body including a recess for receiving the workpiece; and
an opening in the body through which the working electrode lead passes to make contact with the first surface of the workpiece.

3. The electrochemical testing system of claim 2, wherein the sealing mechanism comprises:
a mechanical seal for location between the second surface of the workpiece and the second well portion; and
co-operating engagement members to cause the workpiece and the second well portion to bear against each other.

4. The electrochemical testing system of claim 3, wherein the cooperating engagement members pass through aligned openings formed respectively in the first and second well portions.

5. The electrochemical testing system of claim 3, wherein the cooperating members act to clamp or crimp surfaces of the first and second well portions together.

6. The electrochemical testing system of claim 3, or wherein the mechanical seals of the plurality of testing wells are unitary.

7. The electrochemical testing system of claim 1, wherein one or both of the first well portions and the second well portions of the plurality of testing wells are unitary.

8. The electrochemical testing system of claim 1, wherein the second well portion is formed from a chemically stable, electrically and ionically and/or non-conductive insulating material.

9. The electrochemical testing system of claim 1, wherein the electrochemical sensing elements further comprise one or more of a counter electrode, a reference electrode and test probe.

10. The electrochemical testing system of claim 9, wherein the one or more test probes is any one of a pH sensor or any other ion-selective sensor/probe, a spectroscopic/hyperspectral measurement system/probe or an optical sensor.

11. The electrochemical testing system of claim 1, wherein the at least one sensing head is adapted to secure one or more non-electrochemical sensing elements to perform non-electrochemical testing.

12. The electrochemical testing system of claim 1, wherein the media delivery system comprises:
media delivery tubing running between one or more media storage units and one or more media delivery output nozzles; and
one or more operable pump units to selectively cause delivery of the testing media along the tubing and out of the one or more media delivery output nozzles.

13. The electrochemical testing system of claim 12, wherein the testing media includes one or more of liquids or gel.

14-15. (canceled)

16. The electrochemical testing system of claim 1, wherein the testing apparatus comprises:
at least one electrical instrument having inputs connected to the working electrode lead and one or more of the sensing elements, and an output connected to a measurement recording apparatus.

17. The electrochemical testing system of claim 16, wherein the testing apparatus further comprises:
circuitry for connecting the working electrode lead of a selected testing well to the electrochemical circuit.

18. The electrochemical testing system of claim 1, wherein the motion control system comprises:
a drive mechanism for driving one or both of the plurality of testing wells and sensing head along three orthogonal axes;
a programmable controller configured to control operation of the drive mechanism and the testing apparatus, to control operation of the media delivery system, and to execute a predetermined sequence of testing and/or calibration steps on workpieces held in one or more of the testing wells.

19-21. (canceled)

22. A testing board for use with the electrochemical testing system of claim 1, the testing board including a plurality of testing wells, each well comprising:
a first well portion for holding a workpiece to be tested and bringing a first surface of the workpiece into contact with a working electrode lead,
a second well portion for holding a testing media and bringing a second surface of the workpiece into contact with the testing media, and
a sealing mechanism for preventing contact of the testing media and the first surface of the workpiece;

23. The testing board of claim 22, wherein the first well portion comprises:
a body including a recess for receiving the workpiece; and
an opening in the body through which the working electrode lead passes to make contact with the first surface of the workpiece.

24-29. (canceled)

30. A method for using a testing board to perform electrochemical testing, the testing board including a plurality of testing wells, each well comprising a first well portion for holding a workpiece to be tested and bringing a first surface of the workpiece into contact with a separate working electrode lead for each testing well, a second well portion for holding a testing media and bringing a second surface of the workpiece into contact with the testing media, and a sealing mechanism for preventing contact of the testing media and the first surface of the workpiece, wherein
in an electrochemical testing system including the testing board, a media delivery system, testing apparatus, a motion control system and at least one sensing head for securing one or more electrochemical sensing elements at least one of which is adapted to form part of an electrochemical circuit with the testing media, workpiece and working electrode lead for each testing well, and each testing well is electrically and physically isolated from other testing wells, the method comprising:
selectively delivering the testing media into the second well portion using the media delivery system;
measuring the electrical and/or chemical properties from the electrochemical circuit using the testing apparatus; and
controlling the relative movement between the sensing head and the plurality of testing wells using the motion control system, so that the one or more sensing elements are selectively brought into contact with the testing media in the testing well of a selected workpiece to be tested.

31. (canceled)

32. The method for using a testing board to perform electrochemical testing of claim 30, further comprising at least one of:
(a) running identical testing procedures on the same testing well multiple times; or
(b) loading identical workpieces into a plurality of the testing wells; and
running identical testing procedures on the plurality of testing wells.

33. (canceled)
